(19) United States
(12) Patent Application Publication
(10) Pub. No.: US 2021/0042752 A1
(43) Pub. Date: Feb. 11, 2021

(54) METHODS, SYSTEM AND COMPUTER PROGRAM PRODUCTS FOR IMPLEMENTING AUTHENTICATION WAIVER BASED ELECTRONIC PAYMENT TRANSACTIONS

(71) Applicant: MASTERCARD INTERNATIONAL INCORPORATED, Purchase, NY (US)

(72) Inventors: Anisha GARG, Delhi (IN); Rakesh PATEL, Gurgaon (IN); Ankur ARORA, New Delhi (IN)

(73) Assignee: MASTERCARD INTERNATIONAL INCORPORATED, Purchase, NY (US)

(21) Appl. No.: 16/988,319

(22) Filed: Aug. 7, 2020

(30) Foreign Application Priority Data
Aug. 8, 2019 (IN) 201911032235

(51) Int. Cl. G06Q 20/40

(52) U.S. Cl. CPC G06Q 20/401

(57) ABSTRACT

The disclosure relates to methods and systems for reducing user interventions necessary for authentication of transactions. The disclosure involves (i) receiving from a merchant terminal device, a request for initiating an electronic payment transaction, (ii) retrieving one or more authentication waiver records associated with the transferor payment account, (iii) comparing transaction parameters extracted from the received request with transaction parameters defined in the retrieved one or more authentication waiver records, and (iv) responsive to identifying a retrieved authentication waiver record having transaction parameters that match the transaction parameters extracted from the received request, transmitting to an issuer server (a) an instruction for initiating transfer of the transaction amount, and (b) information identifying the initiated transfer of the transaction amount as exempt from a payor identity authentication requirement.

### CROSS-REFERENCE TO RELATED APPLICATIONS

This application claims priority to Indian Application No. 201911032235, filed Aug. 8, 2019, which is incorporated herein by reference in its entirety.

### TECHNICAL FIELD

The disclosure relates to the field of electronic payment transactions, and more specifically to methods and systems for reducing user interventions necessary for authentication of payment card based electronic payment transactions.

### BACKGROUND

Electronic transactions and payments using payment cards or electronic payment accounts are increasingly common—with the number of electronic payment transactions and ubiquity of electronic transaction mechanisms and services growing steadily.

Electronic transaction systems uniformly implement one or more authentication mechanisms to ensure that requested transactions are only permitted if received from an authorized individual/entity. Authentication mechanisms include several different approaches, including for example, single-factor authentication or multi-factor authentication. Authentication mechanisms can also vary depending on a required level of security—for example, low security transactions can rely on static password/passcode type authentication, while higher security transactions may require one or more of multi-factor authentication, dynamic password generation, biometric authentication, etc.

FIG. 1 illustrates a prior art system environment 100 that is typically used for implementing electronic transactions based on a payment card presented by a card holder at a point-of-sale (POS) terminal device 102. System environment 100 includes the POS terminal device 102, acquirer network 104, card network 106 and issuer network 108. While FIG. 1 has been used to illustrate a payment card based network, it would be understood that similar principles and one or more entities having some or all of the same functions may be used to effect payments through any electronic transaction account or payment account.

Acquirer network 104 may be communicably coupled with POS terminal device 102, and comprises acquirer server 104a, acquirer network database 104b and interface gateway 104c. Acquirer server 104a may be configured to receive and process information relating to payment card transactions. In an embodiment, the acquirer network may receive or process transactions received only from merchants having a merchant account with the acquirer—which determination may be made based on information retrieved from acquirer network database 104b. Interface gateway 104c may include a hardware or software network gateway configured to enable acquirer network 104 to communicate with card network 106.

Card network 106 may be communicably coupled to both acquirer network 104 and issuer network 108.

Issuer network 108 comprises issuer server 108a, issuer network database 108b and interface gateway 108c. Issuer server 108a may be configured to receive and process information relating to payment card transactions. Issuer network database 108b may be configured to store information corresponding to payment cards issued by an issuer institution corresponding to the issuer network. Interface gateway 108c may include a hardware or software network gateway configured to enable issuer network 108 to communicate with card network 106.

In the system of FIG. 1, issuer network 108 may be configured to authenticate the identity of an individual presenting a payment card for executing a payment transaction—as a precondition to authorizing a requested payment transaction received from a POS terminal device 102. In various embodiments known in the prior art, this authentication is implemented through a password/personal identification number (PIN)/one time password (OTP), wherein the issuer network implements a challenge-response type authentication mechanism, through which the user who seeks to execute a payment transaction can submit a password/PIN/OTP to the issuer network, and the submitted password/PIN/OTP can be compared against a stored password/PIN/OTP associated with the legitimate/authorized holder of the payment card.

Subject to a match between the submitted password/PIN/OTP and the stored password/PIN/OTP associated with the legitimate or authorized holder of the payment card, the identity of the user is authenticated and the issuer network proceeds to authorize the requested payment transaction.

FIG. 2 illustrates an exemplary sub-system 200 within issuer network 108, comprising issuer server 202 communicably coupled with authentication server 204. In the illustrated embodiment, responsive to issuer server 202 receiving a payment transaction request from acquirer network 104 through card network 106, issuer server 202 initiates an authentication process flow at authentication server 204—whereinafter authentication server 204 initiates and concludes a challenge-response type authentication process (for example, static password/passcode type authentication, multi-factor authentication, dynamic password based authentication, biometric authentication) with the POS terminal device 102.

It has however been found that incorporation of an authentication process using one or more of passwords/passcodes/dynamic passwords, personal identification numbers, biometric authentication etc., is viewed by card holders as being inconvenient. This view is held even more widely for situations where a payor routinely uses a payment card or payment account for repeating transactions (for example at the same merchant, and for the same type of goods or services availed from said merchant). In such cases, due to the inconvenience of the authentication process, payors often prefer to forego electronic payment transactions entirely, and rely on cash based payments instead—with a view to avoid having to initiating a payment transaction and having to undergo an authentication process for said transaction.

There is accordingly a need to streamline the authentication process for payment card based transactions, by reducing user interventions necessary for authentication of such transactions—particularly for cases where a payor is conducting a transaction that is identical or similar to prior transactions conducted by the same payor or through the same payment card or payment account.

### SUMMARY

The disclosure relates to methods and systems for reducing authentication related user interventions necessary for implementation of electronic payment transactions.

The disclosure provides, methods, systems and computer program products for reducing user interventions necessary for authentication of payment card based electronic payment transactions.

In one embodiment the disclosure provides a method for implementing an electronic payment transaction, comprising (i) receiving from a merchant terminal device, a request for initiating an electronic payment transaction, the received request comprising information corresponding to a transferor payment account, merchant information, and a transaction amount, (ii) retrieving one or more authentication waiver records associated with the transferor payment account, wherein each retrieved authentication waiver record comprises a data record defining parameters of at least one future electronic payment transaction, (iii) comparing transaction parameters extracted from the received request with transaction parameters defined in the retrieved one or more authentication waiver records, and (iv) responsive to identifying a retrieved authentication waiver record having transaction parameters that match the transaction parameters extracted from the received request, transmitting to an issuer server (a) an instruction for initiating transfer of the transaction amount from the transferor payment account to a merchant payment account identified based on the received merchant information, and (b) information identifying the initiated transfer of the transaction amount as exempt from a payor identity authentication requirement.

In a more particular method embodiment, each retrieved authentication waiver record is generated responsive to (i) receiving a payment account authentication waiver request comprising (a) payment account information identifying a payment account for which an authentication waiver is requested, and (b) merchant information identifying an intended merchant recipient of one or more future payment transactions for which the authentication waiver is requested, and (ii) receiving an authentication waiver confirmation decision based on an evaluation of the payment account authentication waiver request, wherein said evaluation is based on application of one or more authentication waiver rules to at least one of information extracted from the payment account authentication waiver request and retrieved transaction history information corresponding to the payment account for which an authentication waiver is requested.

In another embodiment of the method, responsive to receiving the instruction for initiating transfer of the transaction amount and information identifying the initiated transfer of the transaction amount as exempt from a payor identity authentication requirement, the issuer server initiates transfer of the transaction amount from the transferor payment account to the merchant payment account independent of a prior payor identity authentication.

In a specific embodiment of the method, the issuer server is configured such that responsive to receiving an instruction for initiating transfer of a transaction amount without a corresponding identification of the initiated transfer of such transaction amount as exempt from a payor identity authentication requirement, the issuer server initiates transfer of such transaction amount subject to prior payor identity authentication.

The method may involve receiving an authentication waiver confirmation decision responsive to determining that (i) the payment account identified in the payment account authentication waiver request has been used for at least a prescribed number of prior payments to the intended merchant recipient identified in the payment account authentication waiver request, (ii) the payment account identified in the payment account authentication waiver request has been used to transfer at least a prescribed transaction value to the intended merchant recipient identified in the payment account authentication waiver request, or (iii) the intended merchant recipient identified in the payment account authentication waiver request provides a prescribed product or service.

The disclosure also provides a system for implementing an electronic payment transaction. The system comprises a processor implemented transaction server configured to (i) receive from a merchant terminal device, a request for initiating an electronic payment transaction, the received request comprising information corresponding to a transferor payment account, merchant information, and a transaction amount, (ii) retrieve one or more authentication waiver records associated with the transferor payment account, wherein each retrieved authentication waiver record comprises a data record defining parameters of at least one future electronic payment transaction, (iii) compare transaction parameters extracted from the received request with transaction parameters defined in the retrieved one or more authentication waiver records, and (iv) responsive to identifying a retrieved authentication waiver record having transaction parameters that match the transaction parameters extracted from the received request, transmit to an issuer server (a) an instruction for initiating transfer of the transaction amount from the transferor payment account to a merchant payment account identified based on the received merchant information, and (b) information identifying the initiated transfer of the transaction amount as exempt from a payor identity authentication requirement.

The system may be configured such that each retrieved authentication waiver record is generated responsive to (i) receiving a payment account authentication waiver request comprising (a) payment account information identifying a payment account for which an authentication waiver is requested, and (b) merchant information identifying an intended merchant recipient of one or more future payment transactions for which the authentication waiver is requested, and (ii) receiving an authentication waiver confirmation decision based on an evaluation of the payment account authentication waiver request, wherein said evaluation is based on application of one or more authentication waiver rules to at least one of information extracted from the payment account authentication waiver request and retrieved transaction history information corresponding to the payment account for which an authentication waiver is requested.

In an embodiment, the system is configured such that responsive to receiving the instruction for initiating transfer of the transaction amount and information identifying the initiated transfer of the transaction amount as exempt from a payor identity authentication requirement, the issuer server initiates transfer of the transaction amount from the transferor payment account to the merchant payment account independent of a prior payor identity authentication.

The issuer server may be configured such that responsive to receiving an instruction for initiating transfer of a transaction amount without a corresponding identification of the initiated transfer of such transaction amount as exempt from a payor identity authentication requirement, the issuer server initiates transfer of such transaction amount subject to prior payor identity authentication.

In a particular system embodiment, an authentication waiver confirmation decision is received responsive to determining that (i) the payment account identified in the payment account authentication waiver request has been used for at least a prescribed number of prior payments to the intended merchant recipient identified in the payment account authentication waiver request, (ii) the payment account identified in the payment account authentication waiver request has been used to transfer at least a prescribed transaction value to the intended merchant recipient identified in the payment account authentication waiver request, or (iii) the intended merchant recipient identified in the payment account authentication waiver request provides a prescribed product or service.

The disclosure additionally provides a computer program product for implementing an electronic payment transaction. The computer program product comprises a non-transitory computer usable medium having computer readable program code embodied therein, the computer readable program code comprising instructions for (i) receiving from a merchant terminal device, a request for initiating an electronic payment transaction, the received request comprising information corresponding to a transferor payment account, merchant information, and a transaction amount, (ii) retrieving one or more authentication waiver records associated with the transferor payment account, wherein each retrieved authentication waiver record comprises a data record defining parameters of at least one future electronic payment transaction, (iii) comparing transaction parameters extracted from the received request with transaction parameters defined in the retrieved one or more authentication waiver records, and (iv) responsive to identifying a retrieved authentication waiver record having transaction parameters that match the transaction parameters extracted from the received request, transmitting to an issuer server (a) an instruction for initiating transfer of the transaction amount from the transferor payment account to a merchant payment account identified based on the received merchant information, and (b) information identifying the initiated transfer of the transaction amount as exempt from a payor identity authentication requirement.

### BRIEF DESCRIPTION OF THE ACCOMPANYING DRAWINGS

FIG. 1 illustrates a prior art system environment for authenticating and implementing electronic transactions through a payment card transaction system.

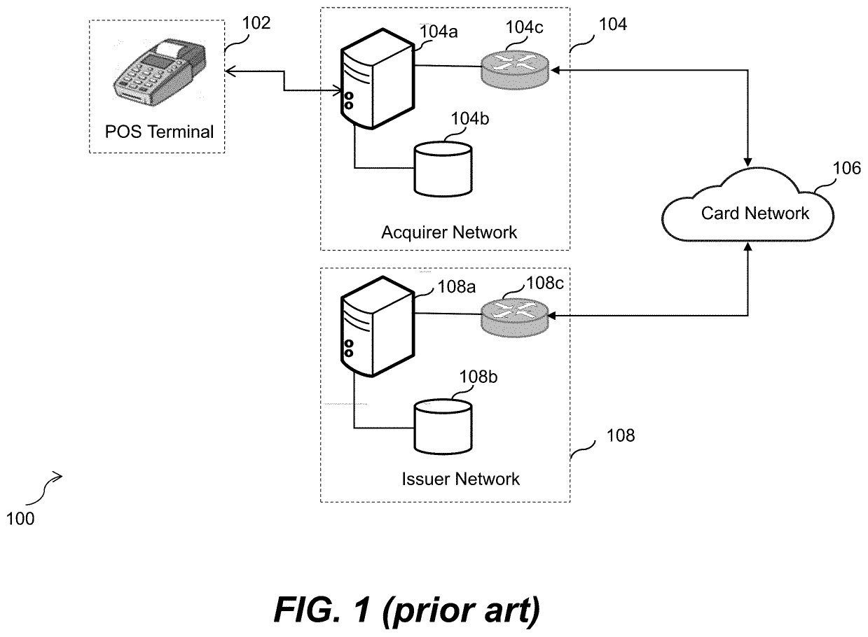

FIG. 2 illustrates issuer network components of the system of FIG. 1.

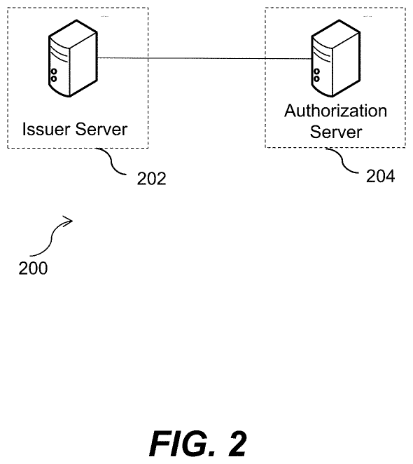

FIG. 3 illustrates a system environment that has been configured for authenticating and implementing electronic transactions through a payment card or payment account based transaction system in accordance with the present disclosure.

FIG. 4 illustrates network components that may be included in the system environment of FIG. 3.

FIG. 5 illustrates a system environment for implementing electronic payment transactions involving an authentication waiver, through a POS terminal.

FIG. 6 illustrates system entities within the system environment of FIG. 3 that have been configured for implementing authentication waiver based electronic payment transactions in accordance with the present disclosure.

FIG. 7 illustrates a method of generating authentication waivers in connection with a payment card or payment account.

FIG. 8 illustrates an exemplary data structure for data records generated by an authentication waiver server in accordance with the teachings of the present disclosure.

FIG. 9 is a communication flow diagram illustrating communication flow between system entities involved in generating authentication waivers in connection with a payment card or payment account.

FIG. 10 illustrates a method of implementing an authentication waiver based electronic payment transaction in accordance with the teachings of the present disclosure.

FIG. 11 is a communication flow diagram illustrating communication flow between system entities involved in implementing an authentication waiver based electronic payment transaction in accordance with the teachings of the present disclosure.

FIG. 12 illustrates an exemplary computer system according to which various embodiments of the present disclosure may be implemented.

### DETAILED DESCRIPTION

The present disclosure provides mechanisms for electronic payment transactions while reducing user interventions necessary to effect such electronic payment transactions.

The disclosure is premised on the understanding that the requirement for a separate authentication step as a prerequisite to authorizing a payment account or payment card based transaction can be done away with, by identifying patterns of payment card or payment account usage based on past transaction data, and permitting for a waiver of authentication requirements in case the parameters of a requested payment card or payment account transaction are found to match or be substantially similar to parameters of prior transactions executed using the same payment card or payment account.

In particular, it has been found that users of payment cards or payment accounts repetitively use their payment cards or payment accounts for similar or identical transactions at the same merchant. For example, a user may use her/his credit card to purchase a cup of coffee from the same coffee shop on a regular basis, or to pay for lunch from the same restaurant on a regular basis. Such instances (and other instances involving the same or similar transaction parameters or transaction environment parameters) results in repetitive patterns of payment card or payment account usage—which patterns may be observed and recorded, so that if in future a similar pattern of payment card or payment account usage is detected, such usage can be safely considered as being legitimate/authorized/conducted by a legitimate card or account holder, and may be subjected to a less stringent authentication procedure, or may be implemented without any authentication whatsoever.

For the purposes of the present disclosure, the following terms shall be understood to have the corresponding meanings provided below:

“Acquirer” shall mean a business (e.g., a financial institution or a merchant bank) that contracts with a merchant to coordinate with the issuer network of a customers' payment card or payment account.

“Acquirer network” shall refer to a communication network, including hardware, software and other equipment used by an acquirer to transmit and process card based or payment account based transactions and information related to merchants, customers, payment cards, payment accounts or payment transactions.

“Card holder”, “Account Holder” or “Customer” shall mean an authorized user of a payment card or payment account who is making a purchase or effecting an electronic transaction with a payment card or payment account.

“Payment network” shall refer to the intermediary between the merchant's acquirer and the customer's issuer (for example, Mastercard® or Visa®). The payment network primarily coordinates payment card or payment account transactions between acquirers and issuers, and additionally coordinates clearing and settlement services to transfer payments from issuers to merchants.

“Issuer” shall mean a financial institution that issues payment cards or payment accounts and maintains a contract with a customer or card holder or account holder for repayment or settlement of purchases made on the payment card.

“Issuer network” shall refer to a communication network, including hardware, software and other equipment used by an issuer to transmit and process payment card transactions and information related to customers, payment cards and transactions.

“Merchant” shall mean an authorized acceptor of payment cards or of payment account information for the payment of goods or services sold by the merchant.

“Payment card” shall mean a card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

“Payment account” shall mean any account that may be used for the purposes of effecting an electronic payment or electronic transaction, and shall include any electronic transaction account, payment card account, bank account or electronic wallet account.

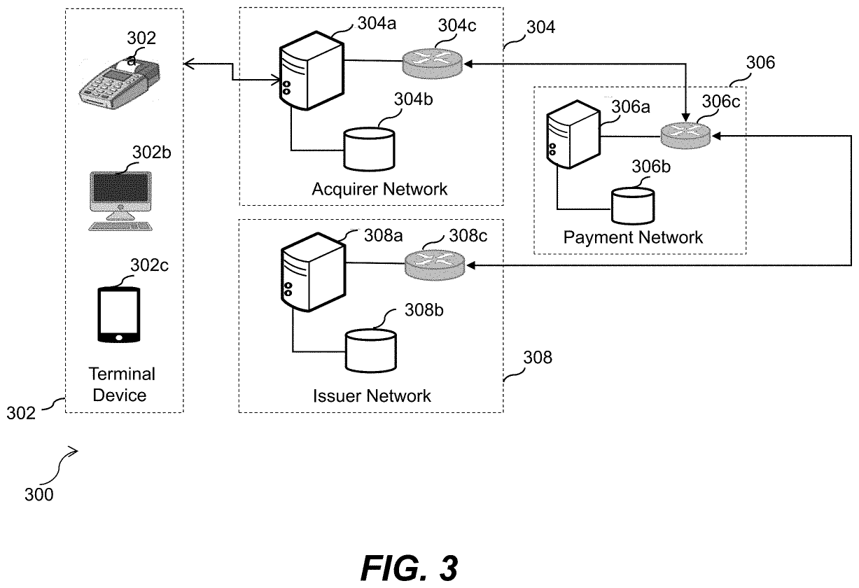

FIG. 3 illustrates a system 300 configured for implementing electronic payment transactions based on a payment card or based on payment account information presented by a card holder or account holder at a terminal device 302—in accordance with the present disclosure.

System 300 includes terminal device 302, acquirer network 304, payment network 306 and issuer network 308 communicably coupled with each other.

Terminal device 302 may comprise any of a POS terminal 302a, a computing device 302b or a mobile computing device or mobile communication device (for example a smartphone device) 302c, or any other network communication enabled data processing device.

Acquirer network 304 may be communicably coupled with terminal device 302, and comprises acquirer server 304a, acquirer network database 304b and interface gateway 304c. Acquirer server 304a may be configured to receive and process information relating to payment card or payment account transactions. In an embodiment, the acquirer network may receive or process transactions received only from merchants having a merchant account with the acquirer—which determination may be made based on information retrieved from acquirer network database 304b. Interface gateway 304c may include a hardware or software network gateway configured to enable acquirer network 304 to communicate with payment network 306.

Payment network 306 may be communicably coupled to both acquirer network 304 and issuer network 308 and optionally may be communicably coupled with terminal device 302. Payment network 306 comprises payment network server 306a, payment network database 306b and payment network interface gateway 306c. Payment network server 306a may be configured to receive and process information relating to payment card or payment account based transactions. Payment network database 306b may comprise a repository of information corresponding to payment cards or payment accounts associated with payment network 306. Payment network interface gateway 306c may include a hardware or software network gateway configured to enable payment network 306 to communicate with one or more of acquirer network 304, issuer network 308 and/or terminal device 302.

Issuer network 308 comprises issuer server 308a, issuer network database 308b and interface gateway 308c. Issuer server 308a may be configured to receive and process information relating to payment card or payment account based transactions. Issuer network database 308b may be configured to store information corresponding to payment cards or payment accounts issued by an issuer institution corresponding to the issuer network 308. Interface gateway 308c may include a hardware or software network gateway configured to enable issuer network 308 to communicate with payment network 306.

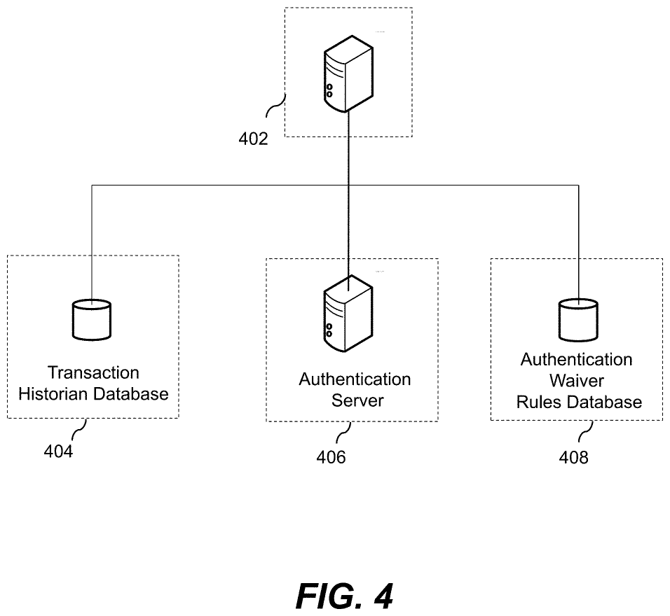

FIG. 4 illustrates a server 402 that configured to be implemented for providing server functionality within either of payment network 306 (for example, in the form of payment network server 306a) and issuer network 308 (for example, in the form of issuer server 308a). Said server 402 may be communicatively coupled with one or more of (i) a transaction historian database 404 configured to store historical transaction records corresponding to payment cards or payment accounts associated with said server 402, (ii) an authentication server 406 configured to authenticate the identity of an individual seeking to initiate an electronic payment transaction through server 402—whereinafter authentication server 204 initiates and concludes a challenge-response type authentication process (for example, static password/passcode type authentication, multi-factor authentication, dynamic password based authentication, biometric authentication) with a terminal from which the electronic payment transaction request is received, and (iii) an authentication waiver rules database 408 configured to store authentication waiver request authorization rules that may be applied in accordance with one or more of the methods described subsequently in this specification—for the purposes of approving or rejecting an electronic payment authentication waiver request received at server 402. The functionality of the respective entities illustrated in FIG. 4 is described in further detail below.

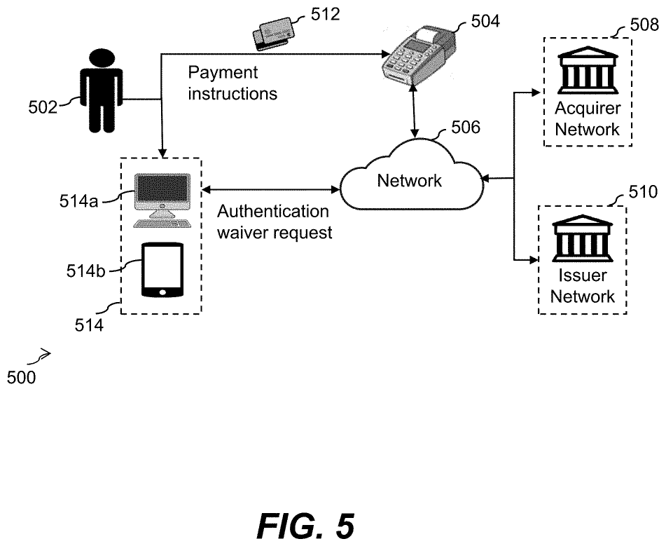

FIG. 5 illustrates a system environment 500 for implementing authentication waiver based electronic payment transactions through a POS terminal in accordance with the teachings of the present disclosure.

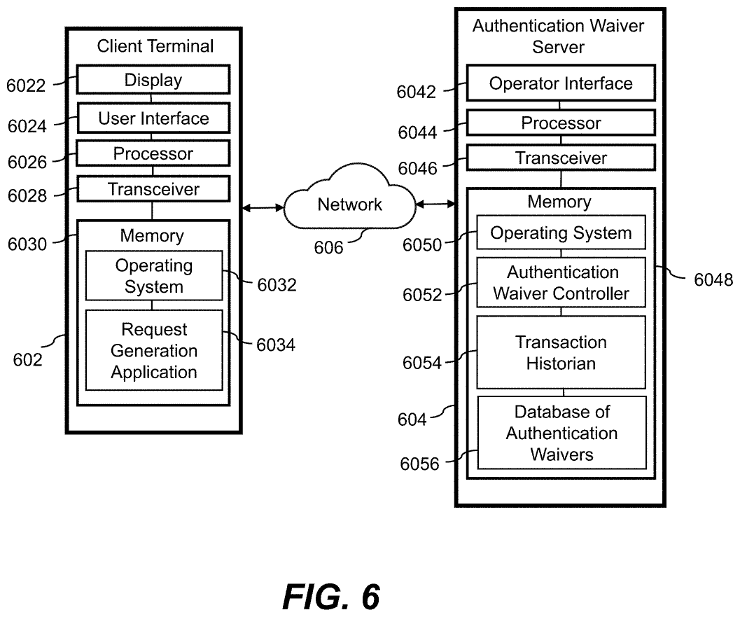

System environment 500 includes payor 502 having a payment card 512. Payor 502 may have access to a client terminal 514 through which payor 502 may request an authentication waiver in respect of future payment transactions that the payor intends to make at one or more merchants. Client terminal 514 may comprise any processor implemented data processing device having network communication capabilities, and may in certain embodiments comprise a computing device 514a or a smartphone 514b or other network communication enabled mobile device. Client terminal 514 may be communicably coupled through network 506 with an authentication waiver server of the type discussed subsequently in this written description (and that is not shown in FIG. 5), which authentication waiver server may be configured to receive from client terminal 514 requests for authentication waiver(s) in respect of future payment transactions that the payor intends to make at one or more merchants, and to approve or reject such authentication waiver requests. The authentication waiver server may be located within network 506 (which may in certain embodiments comprise a payment network associated with a payor's payment card or payment account) or may be located within issuer network 510. Once an authentication waiver has been generated and recorded in respect of one or more future payment transactions that the payor intends to make at one or more merchants, payor 502 may provide payment instructions/initiate a payment transaction using payment card 512 through POS terminal 504 (which is a POS terminal associated with a merchant for whom the payor has secured an authentication waiver)—for example by swiping payment card 512 at POS terminal 504. POS terminal 504 is communicably coupled to network 506, and through network 506 to acquirer network 508 and to issuer network 510. Specific implementations of the manner in which an authentication waiver may be generated, and the manner in which transactions that qualify for authentication waivers may be initiated and concluded within system environment 500, are discussed in connection with FIGS. 6 to 11 below.

FIG. 6 illustrates the interaction between a client terminal 602 and an authentication waiver server 604 that interface with each other for the purpose of generating authentication waivers in connection with intended payment transactions within system environment 500. Client terminal 602 and authentication waiver server 604 are communicably coupled through network 606—which may comprise a communication network, data network or a payment network associated with a payment card or a payment account that a payor intends to use for the payment transaction(s) for which authentication waiver(s) is requested.

Client terminal 602 may comprise any communication terminal configured for network based communication. In specific embodiments, client terminal 602 may comprise a mobile communication device or a smartphone. Said client terminal 602 may include a display 6022, user interface 6024, processor 6026, communication transceiver 6028 and memory 6030, which memory 6030 may include transitory memory and/or non-transitory memory. In an exemplary embodiment, memory 6030 may have stored therewithin, (i) an operating system 6032 configured for managing device hardware and software resources and that provides common services for software programs implemented within client terminal 602, and (ii) a request generation application (which may include a wallet application or a software payment application, or a web browser application or any other software application) 6034 configured to enable payment transaction authentication waiver requests to be generated from client terminal 602.

Authentication waiver server 604 may comprise any processor implemented server device or data processing device configured for network based communication. In specific embodiments, authentication waiver server 604 may include operator interface 6042, processor 6044, communication transceiver 6046 and memory 6048, which memory 6048 may include transitory memory and/or non-transitory memory. In an exemplary embodiment, memory 6048 may have stored therewithin, (i) an operating system 6050 configured for managing device hardware and software resources and that provides common services for software programs implemented within authentication waiver server 604, and (ii) an authentication waiver controller 6052 configured to receive requests for authentication waivers in connection with payment transactions from one or more client terminals 602 and to either approve an authentication waiver request or refuse to approve an authentication waiver request, based on one or more authentication waiver request authorization rules (for example authentication waiver request authorization rules retrieved from authentication waiver rules database 408 that is shown in FIG. 4).

Memory 6048 may additionally include a transaction historian 6054 comprising a database of transactions associated with one or more payment cards or payment accounts associated with a payment network or an issuer network, and which transaction historian 6054 may be used to retrieve transaction history data corresponding to a payment card or payment account for which an authentication waiver request has been initiated at client terminal 602.

Memory 6048 may additionally include a database of authentication waivers 6056, that is used to store information corresponding to one or more authentication waivers that have been generated by authentication waiver server 604—which information may subsequently be retrieved and/or used in response to initiation at a POS terminal of a payment transaction for which an authentication waiver has been generated. In certain embodiments, the database of authentication waivers 6056 may additionally include information regarding authentication waiver requests that have been refused, and/or one or more authentication waiver request authorization rules based on which authentication waiver server 604 can determine whether an authentication waiver request received from client terminal 602 should be approved or refused.

As discussed above, in various embodiments, authentication waiver server 604 may be located within an issuer network associated with a payor, or within a payment network associated with a payment card or payment account associated with the payor.

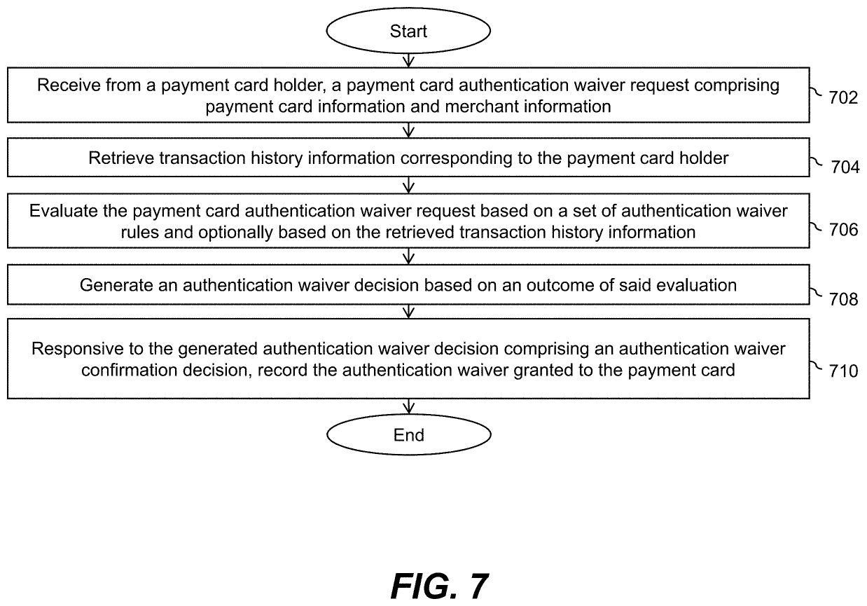

FIG. 7 illustrates a method of generating authentication waivers in connection with a payment card or a payment account. In an embodiment of the disclosure said method may be implemented within an authentication waiver server 604 of the type discussed in connection with FIG. 6.

702 comprises receiving from a payment card holder (or from a client terminal 602 operated by a payment card holder) a payment card authentication waiver request—wherein said request includes (i) payment card information (or payment account information) identifying the payment card (or a payment account) for which an authentication waiver request is being requested, and (ii) merchant information identifying a merchant or a merchant terminal device at which the identified payment card (or payment account) is intended to be utilized for one or more future payments—and for which future payment(s) the authentication waiver is being requested (e.g. merchant name, merchant identifier, merchant type, type of goods or services associated with the merchant, and merchant location). The authentication waiver request may be received at an authentication waiver server 604, and in a specific embodiment may be received by processor 6044 through communication transceiver 6046.

704 comprises retrieving transaction history information corresponding to the payment card or payment account identified at 702. In an embodiment, the transaction history information may be retrieved by the authentication waiver server 604 from a transaction historian database (for example transaction historian 6054 or transaction historian database 404) that is located within or communicably coupled with a payment network or an issuer network associated with the payment card or payment account. In a particular embodiment, the retrieved transaction history information may comprise information corresponding to prior payment transactions involving both of the identified payment card (or payment account) and the identified merchant.

706 comprises evaluating the payment card authentication waiver request based on a set of authentication waiver rules and optionally based on the retrieved transaction history information. The authentication waiver rules may be retrieved by authentication waiver server 604, from an authentication waiver rules database (for example, from authentication waiver rules database 408) and in an embodiment said rules may comprise one or more rules for determining whether the transaction history of the payment card or payment account includes sufficient transaction history information corresponding to prior use of the same payment card or payment account at the same merchant (that has been identified at 702), to indicate that future use of the payment card or the payment account at said merchant is likely to comprise legitimate use of the payment card or the payment account by an individual or entity authorized to make such use. Exemplary, non-limiting embodiments of authentication waiver rules may include:
A rule establishing a minimum number of prior uses of the identified payment card or payment account at the identified merchant—as a prerequisite for authentication waiver
A rule establishing a minimum prior spend amount (either in each individual transactions or cumulatively over a plurality of transactions) using the identified payment card or payment account at the identified merchant—as a prerequisite for authentication waiver
A rule establishing a merchant type or product type or service type (associated with one or more merchants)—as a prerequisite for an authentication waiver
A rule establishing a minimum balance or minimum credit limit associated with the payment card or payment account—as a prerequisite for authentication waiver
A rule establishing one or more payment card holder or payment account holder characteristics (for example, duration of the holder's association with the payment network or financial institution, income of the holder, credit history of the holder, repayment/overdraft history of the holder, annual or monthly spends made by the holder using the payment card or payment account, or spending patterns of the holder)—as a prerequisite for authentication waiver

It would be understood that in cases where the set of authentication rules comprise more than one authentication rules, said rules may be applied either individually or in combination with each other to determine eligibility for authentication waivers.

708 comprises generating an authentication waiver decision based on an outcome of the evaluation at 706. Said authentication waiver decision may be generated at authentication waiver server 604 and in a particular embodiment may be generated by authentication waiver controller 6052. Additionally, the authentication waiver decision may comprise an authentication waiver confirmation decision (i.e. permitting authentication waivers in respect of one or more future transactions initiated using the payment card or payment account) or an authentication waiver rejection decision (i.e. rejecting the request for authentication waivers in respect of one or more future transactions initiated using the payment card or payment account). In certain embodiments, the authentication waiver decision may comprise a conditional authentication waiver confirmation decision, exemplary instances whereof may include—
An authentication waiver in case the future transaction is for an amount that falls within a specified monetary limit
An authentication waiver in case the future transaction is for payment towards a specific product(s) or service(s)
An authentication waiver in case the future transaction is implemented within a specified duration of time
An authentication waiver only in cases where the future transaction satisfies a predefined degree of similarity with one or more prior transactions that have been executed by the holder of the payment card or the payment account based on compliance with one or more authentication requirements

At 710, responsive to the generated authentication waiver decision comprising an authentication waiver confirmation decision, information representing the granted authentication waiver may be recorded in a database and associated with the payment card or payment account identified at 702. Recording said information may be implemented by authentication waiver server 604 and the information may be recorded in a database located within or communicably coupled with the payment network or the issuer network associated with the payment card or payment account. In a specific embodiment, the information representing the granted authentication waiver may be recorded in a database of authentication waivers 6056.

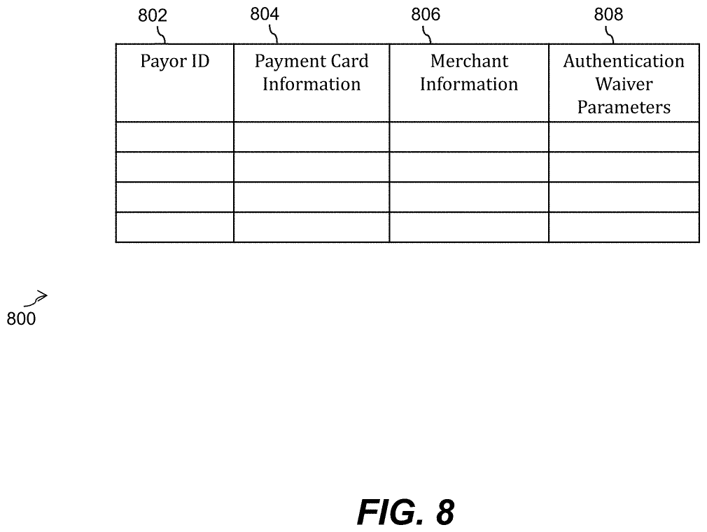

FIG. 8 illustrates an exemplary embodiment of data structure 800 configured for storing data records maintained by a payment network or an issuer network for the purposes of recording granted authentication waivers in accordance with 710 of FIG. 7. In an embodiment, data structure 800 is used to store data records within database of authentication waivers 6056.

Each data record within data structure 800 comprises a plurality of data fields including on or more of (i) a payor ID data field 802 configured to record a unique identifier associated with a payor (or holder of a payment account or payment card) associated with a granted authentication waiver, (iii) a payment card information data field 804 configured to record information corresponding to a payment card or a payment account (e.g. payment card/account number, CVV number and/or expiry date, issuer institution etc.) that has been identified in the request for an authentication waiver, (iii) a merchant information data field 806 configured to record information defining or describing a merchant intended to be involved in a payment transaction for which the authentication waiver has been granted (e.g. merchant name, merchant identifier, merchant type, type of goods or services associated with the merchant, and merchant location), and (vi) an authentication waiver parameters data field 808—configured to record one or more conditions or parameters that have been associated with a granted authentication waiver and which would require to be satisfied for waiver of the transaction authentication requirement (e.g. a maximum transaction value limit, a permitted transaction type, product type or service type, a permitted transaction implementation time window, and/or one or more similarity requirements in comparison with one or more prior transactions that have been executed by the holder of the payment card or the payment account).

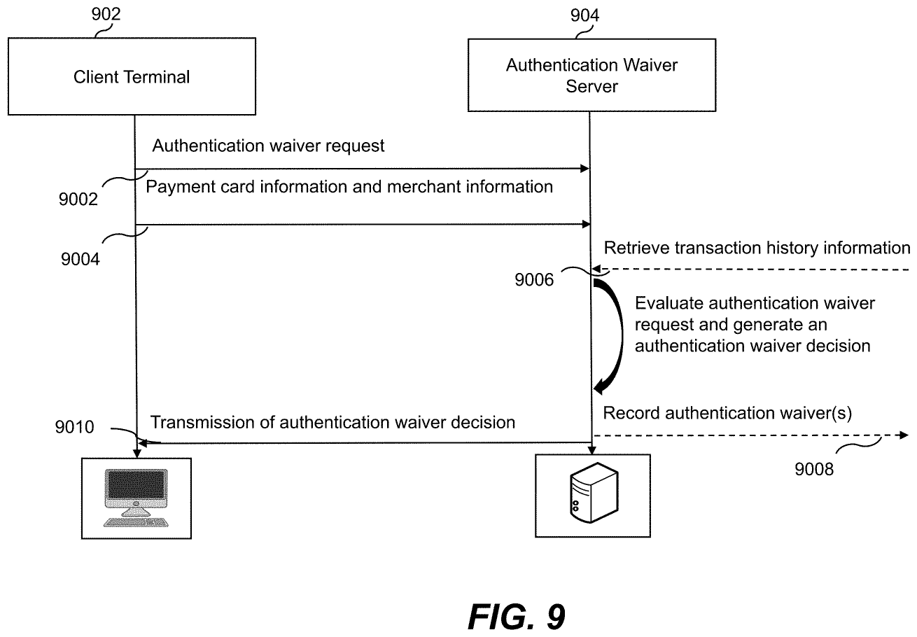

FIG. 9 illustrates a communication flow between the system components illustrated in FIG. 6 in implementing the method of FIG. 7.

The method commences at 9002 wherein client terminal 902 transmits an authentication waiver request to authentication waiver server 904.

9004 comprises transmitting from client terminal to authentication waiver server 904 (i) payment card information (or payment account information) identifying the payment card (or a payment account) for which an authentication waiver request is being requested, and (ii) merchant information identifying a merchant or a merchant terminal device at which the identified payment card (or payment account) is intended to be utilized for one or more future payments.

9006 comprises retrieving at authentication waiver server 904, transaction history information corresponding to the payment card or payment account whose information has been received at authentication waiver server 904 as a consequence of 9002.

Authentication waiver server 904 subsequently evaluates the authentication waiver request (based on a set of authentication waiver rules and optionally based on the retrieved transaction history information) and generates an authentication waiver decision.

Responsive to the authentication waiver decision comprising an authentication waiver confirmation decision, the granted authentication waiver is recorded at 9008—for example, within a database of authentication waivers 6056.

At 9010 the generated authentication waiver decision is transmitted to client terminal 902 for intimation purposes.

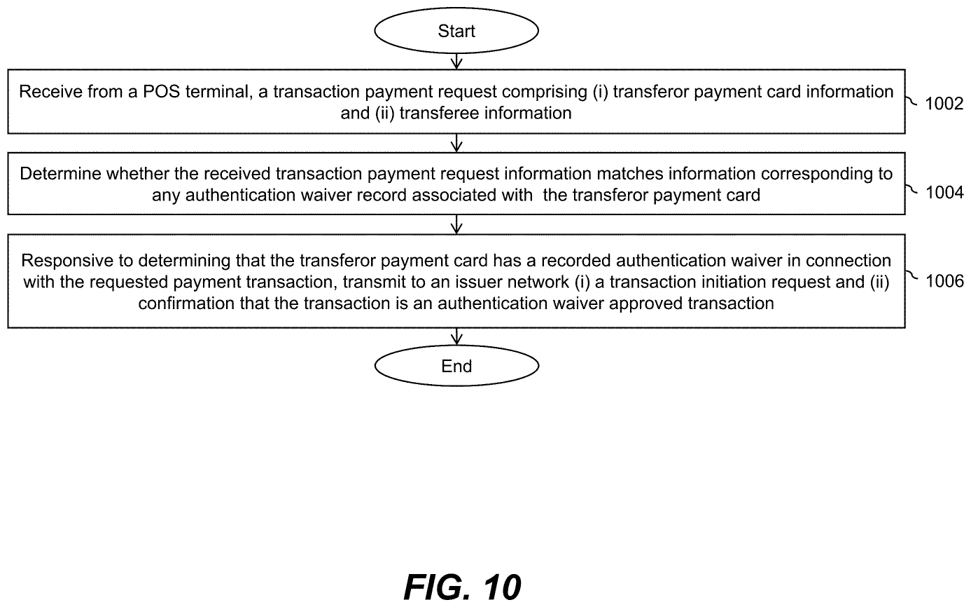

FIG. 10 illustrates a method of implementing an authentication waiver based electronic payment transaction in accordance with the teachings of the present disclosure.

1002 comprises receiving from a POS terminal, an electronic transaction payment request comprising (i) transferor payment card or payment account information, and (ii) transferee information. In an embodiment of the disclosure, said request may be received at a server within network 506 or within issuer network 510, from POS terminal 504.

The transferor payment card information or payment account information may in an embodiment include information corresponding to a payment card or payment account that has been presented or input at POS terminal 504 and that is intended to be used to implement the requested payment transaction (which information may include a card number or account number, and one or more other elements of card information or account information, including for example the card expiry date and/or CVC or CVV number, and an identifier associated with an issuer institution). Likewise, the transferee information may include merchant information including merchant identity information and merchant payment account information. In an embodiment, the transferee information may include one or more items of information retrieved from a memory within POS terminal 504. The transferee payment card information or payment account information may in an embodiment include one or more of a transferee account number, and one or more other elements of account information including for example an identifier associated with an acquirer institution with whom the transferee payment account is held.

The transaction payment request received at 1002 may additionally include information identifying the transaction amount.

1004 comprises determining whether the received transaction payment request information matches information corresponding to any authentication waiver record associated with the transferor payment card. In an embodiment, execution of 1004 comprises retrieving from a database of authentication waivers 6056, information corresponding to generated authentication waivers that have been associated with the transferor payment card or payment account, and parsing the retrieved information to determine whether the information received at 1002 matches any of the retrieved authentication waiver data records. Stated differently, 1004 comprises comparing the information received from the POS terminal 504 at 1002, with information from a database of authentication waivers 6056 to determine whether a requested payment transaction qualifies for an authentication waiver that has been previously generated and stored in said database. It would be understood that the determination of 1004 may in an embodiment involve matching one or more items of information received at 1002 from the POS terminal 504 against one or more data records retrieved from the database of authentication waiver records 6056 to ascertain whether the parameters of the requested payment transaction match the recorded parameters of any authentication waiver(s) that have been previously approved in connection with the transferor payment card or payment account. In particular embodiments of the disclosure the parameters corresponding to the requested payment transaction that are evaluated and compared against data parameters extracted from the database of authentication waivers 6056 for the purposes of matching at 1004, may include one or more of merchant identifier, merchant product or merchant service identifier, transaction amount, and/or transaction time stamp.

In an embodiment of the disclosure, 1004 may be implemented at a server within network 506 or within issuer network 510.

Responsive to determining that the transferor payment card or payment account has a recorded authentication waiver that applies to the requested payment transaction, 1006 comprises transmitting to a server within an issuer network (i) a transaction payment initiation request and (ii) information identifying the transaction as a transaction to which an authentication waiver applies.

The transaction payment initiation request transmitted at 1006 may include at least the transferor payment card or payment account information, transferee payment account information and the payment amount. The information identifying the transaction as a transaction to which an authentication waiver applies may be transmitted as a data element or data flag within the transaction payment initiation request, or alternately as part of a separate data message.

Upon receipt at the issuer network, of (i) a transaction payment initiation request and (ii) information identifying the transaction as a transaction to which an authentication waiver applies, the issuer network initiates payment of the transaction amount from the transferor account to the transferee account without first triggering an identity authentication process flow.

Accordingly, in an embodiment of the disclosure, upon receipt of a transaction payment initiation request from a payment network, the issuer network (or a server within the issuer network) checks for an associated or accompanying data message or data element identifying the transaction as a transaction to which an authentication waiver applies. Responsive to receiving such data message or data element identifying the transaction as a transaction to which an authentication waiver applies, the issuer network initiates payment of the transaction amount from the transferor account to the transferee account without triggering a preliminary identity authentication process flow, whereas if such data message or data element is not received, the issuer first initiates an identity authentication process flow, and only proceeds to execution of the requested electronic payment subsequent to satisfactory authentication of the transferor's identity.

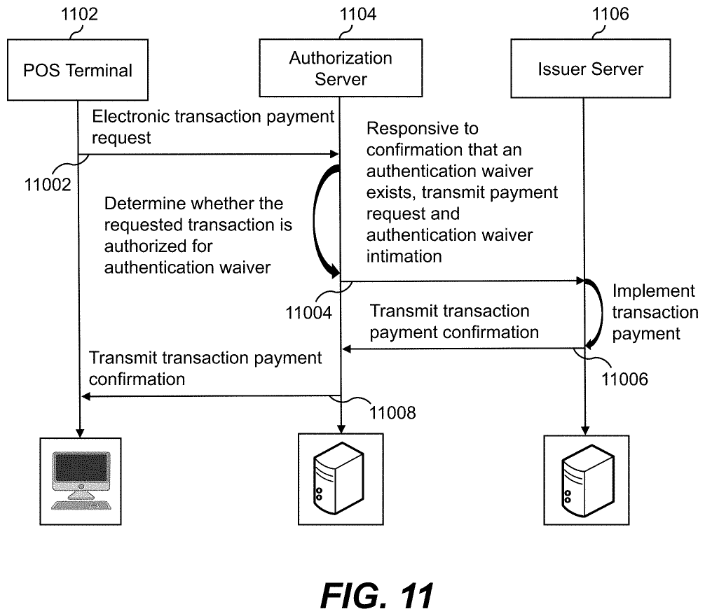

FIG. 11 is a communication flow diagram illustrating communication flow between system entities involved in implementing an authentication waiver based electronic payment transaction in accordance with the method discussed in connection with FIG. 10.

11002 of FIG. 11 comprises transmission of an electronic transaction payment request from POS terminal 1102 to an authorization server 1104. As discussed in connection with FIG. 10, said request may include (i) transferor payment card or payment account information, (ii) transferee information and (iii) payment amount information.

Authorization server 1104 thereafter determines whether the requested transaction has been authorized for an authentication waiver. Said determination may in an embodiment be implemented in accordance with method 1004 of FIG. 10.

At 11004, responsive to a positive determination that the requested transaction has been authorized for an authentication waiver, authorization server 1104 transmits the request for electronic payment and intimation of the authentication waiver to issuer server 1106.

Issuer server 1106 thereafter implements the requested electronic transaction payment—which payment is implemented without triggering a preliminary identity authentication process flow. At 11006 confirmation that the transaction payment has been completed is transmitted from issuer server 1106 to authorization server 1104. At 11008, confirmation that the transaction payment has been completed is transmitted from authorization server 1104 to POS terminal 1102.

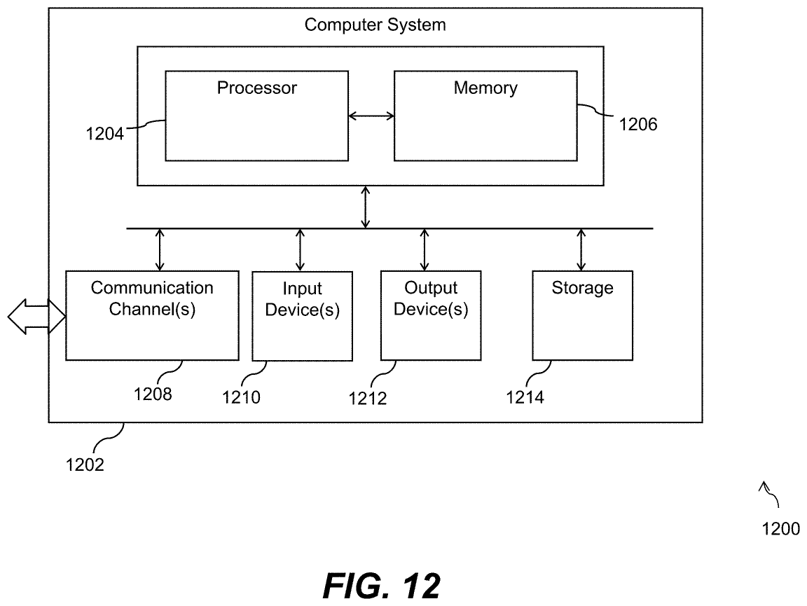

FIG. 12 illustrates an exemplary system 1200 for implementing the present disclosure.

System 1200 includes computer system 1202 which in turn comprises one or more processors 1204 and at least one memory 1206. Processor 1204 is configured to execute program instructions—and may be a real processor or a virtual processor. It will be understood that computer system 1202 does not suggest any limitation as to scope of use or functionality of described embodiments. The computer system 1202 may include, but is not be limited to, one or more of a general-purpose computer, a programmed microprocessor, a micro-controller, an integrated circuit, and other devices or arrangements of devices that are capable of implementing the operations that constitute the method of the present disclosure. Exemplary embodiments of a computer system 1202 in accordance with the present disclosure may include one or more servers, desktops, laptops, tablets, smart phones, mobile phones, mobile communication devices, tablets, phablets and personal digital assistants. In an embodiment of the present disclosure, the memory 1206 may store software for implementing various embodiments of the present disclosure. The computer system 1202 may have additional components. For example, the computer system 1202 may include one or more communication channels 1208, one or more input devices 1210, one or more output devices 1212, and storage 1214. An interconnection mechanism (not shown) such as a bus, controller, or network, interconnects the components of the computer system 1202. In various embodiments of the present disclosure, operating system software (not shown) provides an operating environment for various softwares executing in the computer system 1202 using a processor 1204, and manages different functionalities of the components of the computer system 1202.

The communication channel(s) 1208 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 1210 may include, but is not limited to, a touch screen, a keyboard, mouse, pen, joystick, trackball, a voice device, a scanning device, or any another device that is capable of providing input to the computer system 1202. In an embodiment of the present disclosure, the input device(s) 1210 may be a sound card or similar device that accepts audio input in analog or digital form. The output device(s) 1212 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 1202.

The storage 1214 may include, but not be limited to, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1202. In various embodiments of the present disclosure, the storage 1214 may contain program instructions for implementing any of the described embodiments.

In an embodiment of the present disclosure, the computer system 1202 is part of a distributed network or a part of a set of available cloud resources.

The present disclosure may be implemented in numerous ways including as a system, a method, or a computer program product such as a computer readable storage medium or a computer network wherein programming instructions are communicated from a remote location.

The present disclosure may suitably be embodied as a computer program product for use with the computer system 1202. The method described herein is typically implemented as a computer program product, comprising a set of program instructions that is executed by the computer system 1202 or any other similar device. The set of program instructions may be a series of computer readable codes stored on a tangible medium, such as a computer readable storage medium (storage 1214), for example, diskette, CD-ROM, ROM, flash drives or hard disk, or transmittable to the computer system 1202, via a modem or other interface device, over either a tangible medium, including but not limited to optical or analogue communications channel(s) 1208. The implementation of the disclosure as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it would be apparent that the present disclosure offers significant advantages—in particular, by reducing the requirement for user interventions and by offering convenient and secure ways for implementing electronic payment transactions while eliminating or reducing the requirement for prior identity authentication of the payor. The disclosure offers significant improvement in customer experience due to the fact that the degree of effort or active intervention on the part of the payor for commencing and/or carrying out an electronic or payment card based transaction is reduced, without adversely affecting security standards.

While the exemplary embodiments of the present disclosure are described and illustrated herein, it will be appreciated that they are merely illustrative. It will be understood by those skilled in the art that various modifications in form and detail may be made therein without departing from or offending the spirit and scope of the disclosure as defined by the appended claims. Additionally, the disclosure illustratively disclose herein suitably may be practiced in the absence of any element which is not specifically disclosed herein—and in a particular embodiment that is specifically contemplated, the disclosure is intended to be practiced in the absence of any one or more element which are not specifically disclosed herein.

1. A method for implementing an electronic payment transaction, comprising:
receiving, by a processor, from a merchant terminal device, a request to initiate an electronic payment transaction, the received request comprising:
information corresponding to a transferor payment account;
merchant information; and
a transaction amount;
retrieving, by the processor, one or more authentication waiver records associated with the transferor payment account, wherein each retrieved authentication waiver record comprises a data record defining parameters of at least one future electronic payment transaction;
comparing, by the processor, transaction parameters extracted from the received request with transaction parameters defined in the retrieved one or more authentication waiver records; and
responsive to identifying a retrieved authentication waiver record having transaction parameters that match the transaction parameters extracted from the received request, transmitting, by the processor, to an issuer server:
an instruction to initiate transfer of the transaction amount from the transferor payment account to a merchant payment account identified based on the received merchant information; and
information identifying the initiated transfer of the transaction amount as exempt from a payor identity authentication requirement.

2. The method as claimed in claim 1, wherein each retrieved authentication waiver record is generated responsive to:
receiving a payment account authentication waiver request comprising (i) payment account information identifying a payment account for which an authentication waiver is requested, and (ii) merchant information identifying an intended merchant recipient of one or more future payment transactions for which the authentication waiver is requested; and
receiving an authentication waiver confirmation decision based on an evaluation of the payment account authentication waiver request, wherein said evaluation is based on application of one or more authentication waiver rules to at least one of information extracted from the payment account authentication waiver request and retrieved transaction history information corresponding to the payment account for which an authentication waiver is requested.

3. The method as claimed in claim 1, wherein responsive to receiving the instruction to initiate transfer of the transaction amount and information identifying the initiated transfer of the transaction amount as exempt from a payor identity authentication requirement, the issuer server initiates transfer of the transaction amount from the transferor payment account to the merchant payment account independent of a prior payor identity authentication.

4. The method as claimed in claim 1, wherein the issuer server is configured such that responsive to receiving an instruction to initiate transfer of the transaction amount without the information identifying the initiated transfer of the transaction amount as exempt from the payor identity authentication requirement, the issuer server initiates transfer of the transaction amount subject to prior payor identity authentication.

5. The method as claimed in claim 2, wherein an authentication waiver confirmation decision is received responsive to determining that:
the payment account identified in the payment account authentication waiver request has been used for at least a prescribed number of prior payments to the intended merchant recipient identified in the payment account authentication waiver request;
the payment account identified in the payment account authentication waiver request has been used to transfer at least a prescribed transaction value to the intended merchant recipient identified in the payment account authentication waiver request; or
the intended merchant recipient identified in the payment account authentication waiver request provides a prescribed product or service.

6. A system for implementing an electronic payment transaction, comprising:
a transaction server comprising a processor programmed to:
receive, from a merchant terminal device, a request to initiate an electronic payment transaction, the received request comprising:
information corresponding to a transferor payment account;
merchant information; and
a transaction amount;
retrieve one or more authentication waiver records associated with the transferor payment account, wherein each retrieved authentication waiver record comprises a data record defining parameters of at least one future electronic payment transaction;
compare transaction parameters extracted from the received request with transaction parameters defined in the retrieved one or more authentication waiver records; and
responsive to identifying a retrieved authentication waiver record having transaction parameters that match the transaction parameters extracted from the received request, transmit to an issuer server:
an instruction for initiating transfer of the transaction amount from the transferor payment account to a merchant payment account identified based on the received merchant information; and
information identifying the initiated transfer of the transaction amount as exempt from a payor identity authentication requirement.

7. The system as claimed in claim 6, wherein each retrieved authentication waiver record is generated responsive to:
receiving a payment account authentication waiver request comprising (i) payment account information identifying a payment account for which an authentication waiver is requested, and (ii) merchant information identifying an intended merchant recipient of one or more future payment transactions for which the authentication waiver is requested; and
receiving an authentication waiver confirmation decision based on an evaluation of the payment account authentication waiver request, wherein said evaluation is based on application of one or more authentication waiver rules to at least one of information extracted from the payment account authentication waiver request and retrieved transaction history information corresponding to the payment account for which an authentication waiver is requested.

8. The system as claimed in claim 6, wherein responsive to receiving the instruction to initiate transfer of the transaction amount and information identifying the initiated transfer of the transaction amount as exempt from a payor identity authentication requirement, the issuer server initiates transfer of the transaction amount from the transferor payment account to the merchant payment account independent of a prior payor identity authentication.

9. The system as claimed in claim 7, wherein the issuer server is configured such that responsive to receiving an instruction to initiate transfer of the transaction amount without the information identifying the initiated transfer of transaction amount as exempt from the payor identity authentication requirement, the issuer server initiates transfer of the transaction amount subject to prior payor identity authentication.

10. The system as claimed in claim 7, wherein an authentication waiver confirmation decision is received responsive to determining that:
the payment account identified in the payment account authentication waiver request has been used for at least a prescribed number of prior payments to the intended merchant recipient identified in the payment account authentication waiver request;
the payment account identified in the payment account authentication waiver request has been used to transfer at least a prescribed transaction value to the intended merchant recipient identified in the payment account authentication waiver request; or
the intended merchant recipient identified in the payment account authentication waiver request provides a prescribed product or service.

11. A computer readable medium for implementing an electronic payment transaction, comprising a non-transitory computer usable medium having computer readable program code embodied therein, the computer readable program code comprising instructions that, when executed by a processor, program the processor to:
receive, from a merchant terminal device, a request to initiate an electronic payment transaction, the received request comprising:
information corresponding to a transferor payment account;
merchant information; and
a transaction amount;
retrieve one or more authentication waiver records associated with the transferor payment account, wherein each retrieved authentication waiver record comprises a data record defining parameters of at least one future electronic payment transaction;
compare transaction parameters extracted from the received request with transaction parameters defined in the one or more authentication waiver records; and
responsive to identification of a retrieved authentication waiver record having transaction parameters that match the transaction parameters extracted from the received request, transmit, to an issuer server:
an instruction to initiate a transfer of the transaction amount from the transferor payment account to a merchant payment account identified based on the received merchant information; and
information identifying the initiated transfer of the transaction amount as exempt from a payor identity authentication requirement.

12. The computer readable medium of claim 11, wherein the transaction parameters defined in the one or more authentication waiver records comprise merchant identifying information that identifies a merchant at which the payor identity authentication requirement is to be waived when the transferor payment account is used for electronic payment transactions with the merchant.

13. The computer readable medium of claim 11, wherein the instructions further program the processor to:
receive, from a second merchant terminal device, a second request to initiate a second electronic payment transaction, the received second request comprising:
information corresponding to the transferor payment account;
second merchant information identifying a second merchant; and
a second transaction amount;
determine, based on the received second request and the one or more authentication waiver records, that the second electronic payment transaction is not subject to a waiver of the payor identity authentication requirement; and
transmit, to an issuer server, without information identifying the initiated second transfer of the second transaction amount as exempt from the payor identity authentication requirement, a second instruction to initiate a second transfer of the second transaction amount from the transferor payment account to a second merchant payment account identified based on the received second merchant information.

14. The computer readable medium of claim 11, wherein the instructions further program the processor to:
receive a payment account authentication waiver request to waive the payor identity authentication requirement in connection with use of the transferor payment account;
access one or more authentication waiver rules;
apply the one or more authentication waiver rules;
grant the payment account authentication waiver request based on the applied one or more authentication waiver rules; and
generate an authentication waiver record based on the applied one or more authentication waiver rules, the authentication waiver record indicating that the use of the transferor payment account is exempt from the payor identity authentication requirement.

15. The computer readable medium of claim 14, wherein to apply the one or more authentication waiver rules, the instructions further program the processor to:
determine that the use of the transferor payment account for electronic payment transactions with a merchant are likely to be legitimate based on the applied one or more authentication waiver rules; wherein the authentication waiver record identifies the merchant at which the use of the transferor payment account is exempt from the payor identity authentication requirement.

16. The computer readable medium of claim 15, wherein the one or more authentication waiver rules comprise a rule that specifies a minimum number of prior uses of the transferor payment account at the merchant, and wherein to determine that the use of the transferor payment account for electronic payment transactions with the merchant are likely to be legitimate, the instructions further program the processor to:
access transaction history information associated with the transferor payment account;
determine, based on the transaction history information, whether a number of prior uses of the transferor payment account at the merchant satisfies the minimum number.

17. The computer readable medium of claim 14, wherein the one or more authentication waiver rules comprise a rule that specifies a minimum spend amount previously made with the transferor payment account at a merchant for which the waiver of the payor identity authentication requirement is to be applied, and wherein to apply the one or more authentication waiver rules, the instructions further program the processor to:
access transaction history information associated with the transferor payment account;
determine, based on the transaction history information, whether a spend amount of the transferor payment account at the merchant satisfies the minimum spend amount.

18. The computer readable medium of claim 14, wherein the one or more authentication waiver rules comprise a rule that specifies a pre-requisite merchant type of a merchant for which the waiver of the payor identity authentication requirement is to be applied, and wherein to apply the one or more authentication waiver rules, the instructions further program the processor to:
determine whether a merchant type of the merchant satisfies the pre-requisite merchant type.

19. The computer readable medium of claim 14, wherein the one or more authentication waiver rules comprise a rule that specifies a minimum balance or credit limit, and wherein to apply the one or more authentication waiver rules, the instructions further program the processor to:
determine whether a balance or credit limit of the transferor payment account satisfies the minimum balance or credit limit.

20. The computer readable medium of claim 14, wherein the one or more authentication waiver rules comprise a rule that specifies one or more pre-requisite characteristics of the payor, and wherein to apply the one or more authentication waiver rules, the instructions further program the processor to:
determine whether a characteristic of the payor satisfies the one or more pre-requisite characteristics.
